(19) United States
(12) Patent Application Publication
(10) Pub. No.: US 2018/0312381 A1
(43) Pub. Date: Nov. 1, 2018

(54) CARGO LOWERING SLIDE ASSEMBLY

(71) Applicant: OnScene Solutions, LLC, Fort Collins, CO (US)

(72) Inventor: Ronald L. Weinmeister, Fort Collins, CO (US)

(73) Assignee: OnScene Solutions, LLC, Fort Collins, CO (US)

(21) Appl. No.: 15/963,023

(22) Filed: Apr. 25, 2018

Related U.S. Application Data
(60) Provisional application No. 62/490,594, filed on Apr. 26, 2017.

(51) Int. Cl. B66F 9/02; B60P 1/44

(52) U.S. Cl. CPC B66F 9/02; B66F 2700/04; B66F 2700/05; B60P 1/4442

(57) ABSTRACT

The present invention is directed to the problem of maneuvering heavy cargo to an ergonomically correct lifting height for countless industries, including for equipment stored on firefighting and rescue vehicles. Mechanical and electrically actuated horizontal drawer slides and extendable arms enable loads to be moved outside of an enclosure or storage structure for easier access.

### CROSS REFERENCE TO RELATED APPLICATIONS

The present application claims the benefit of U.S. Provisional Patent Application No. 62/490,594, filed Apr. 26, 2017, entitled “Cargo Lowering Slide Assembly,” which is incorporated by reference in its entirety.

### FIELD OF THE INVENTION

The present invention is directed to the problem of how to properly maneuver heavy cargo to an ergonomically correct lifting height is a problem for countless industries, including for equipment stored on firefighting and rescue vehicles. Mechanical and electrically actuated horizontal drawer slides enable loads to be moved outside of an enclosure or storage structure for easier access. However, the height of the horizontal drawer slide is dictated by the structure of the vehicle and is often too high or too low for safe lifting of heavy cargo from the horizontal drawer slide. The user must therefore lift the heavy equipment from an awkward and potential dangerous height and risks bodily injury.

### SUMMARY OF THE INVENTION

The present invention is a cargo lowering slide assembly that achieves horizontal and extended mobility of a cargo platform from a storage compartment as well as vertical mobility of the cargo platform once outside of the storage compartment. The referenced cargo lowering slide assembly generally refers to the completed assembly of all components allowing these types of movements. The reference to a “slide assembly” is to a component of the cargo lowering slide assembly that facilitates the horizontal travel of the cargo platform.

The cargo lowering slide assembly with the features listed below, will greatly enhance cargo handling capabilities for numerous industries and allow for more ergonomically correct and safe lifting advantages over what currently exists.

In certain embodiments of the present invention, the cargo lowering slide assembly includes partial or complete electric, electric/hydraulic, or air-actuated horizontal and vertical actuation of the drawer slide and lifting arms; 30.0+ inches of vertical lifting cargo platform travel; 500 pound and above weight capacity; construction materials including aluminum and stainless steel construction; and customizable sizing to accommodate various enclosure and cargo platform sizes.

Certain embodiments of the present invention comprise one or more components that automatically controlled by computer hardware and/or computer software by way of a controller element. In an exemplary embodiment, the positioning and/or orientation of one or more components are automatically positioned to a set orientation based on a profile inputted by a manufacturer or user. Alternatively or additionally, the controller may access a database of user profiles, and/or set generic user profiles, and adjust the cargo lowering slide assembly to satisfy those profiles. In certain embodiments, the user inputs desired cargo platform extension and lowering position or settings by way of a display, screen or graphical user interface.

The present disclosure can provide a number of advantages depending on the particular aspect, embodiment, and/or configuration.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any storage and/or transmission medium that participate in providing instructions to a processor for execution. Such a computer-readable medium is commonly tangible, non-transitory, and non-transient and can take many forms, including but not limited to, non-volatile media, volatile media, and transmission media and includes without limitation random access memory (“RAM”), read only memory (“ROM”), and the like. Nonvolatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The terms “determine,” “calculate,” and “compute,” and variations thereof, as used herein, are used interchangeably and include any type of methodology, process, mathematical operation, or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that can perform the functionality associated with that element.

The term “screen,” “touch screen,” or “touchscreen” refers to a physical structure that includes one or more hardware components that provide the device with the ability to render a user interface and/or receive user input. A screen can encompass any combination of gesture capture region, a touch sensitive display, and/or a configurable area. The device can have one or more physical screens 3 embedded in the hardware. However, a screen may also include an external peripheral device that may be attached and detached from the device. In embodiments, multiple external devices may be attached to the device. Thus, in embodiments, the screen can enable the user to interact with the device by touching areas on the screen and provides information to a user through a display. The touch screen may sense user contact in many ways, such as by a change in an electrical parameter (e.g., resistance or capacitance), acoustic wave variations, infrared radiation proximity detection, light variation detection, and the like. In a resistive touch screen, for example, normally separated conductive and resistive metallic layers in the screen pass an electrical current. When a user touches the screen, the two layers make contact in the contacted location, whereby a change in electrical field is noted and the coordinates of the contacted location calculated. In a capacitive touch screen, a capacitive layer stores electrical charge, which is discharged to the user upon contact with the touch screen, causing a decrease in the charge of the capacitive layer. The decrease is measured, and the contacted location coordinates determined. In a surface acoustic wave touch screen, an acoustic wave is transmitted through the screen, and the acoustic wave is disturbed by user contact. A receiving transducer detects the user contact instance and determines the contacted location coordinates.

The term “display” refers to a portion of one or more screens used to display the output of a computer to a user. A display may be a single-screen display or a multi-screen display, referred to as a composite display. A composite display can encompass the touch sensitive display of one or more screens. A single physical screen can include multiple displays that are managed as separate logical displays. Thus, different content can be displayed on the separate displays although part of the same physical screen.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future developed standard, instruction set, libraries, and/or architecture.

Furthermore, while the exemplary aspects, embodiments, and/or configurations illustrated herein show the various components of the system collocated, certain components of the system may be located remotely, at distant portions of a distributed network, such as a LAN and/or the Internet, or within a dedicated system. Thus, it should be appreciated, that the components of the system may be combined in to one or more devices, or collocated on a particular node of a distributed network, such as an analog and/or digital telecommunications network, a packet-switch network, or a circuit-switched network. It will be appreciated from the preceding description, and for reasons of computational efficiency, that the components of the system may be arranged at any location within a distributed network of components without affecting the operation of the system. For example, the various components may be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements may be wired or wireless links, or any combination thereof, or any other known or later developed element(s) that is capable of supplying and/or communicating data to and from the connected elements. These wired or wireless links may also be secure links and may be capable of communicating encrypted information. Transmission media used as links, for example, may be any suitable carrier for electrical signals, including coaxial cables, copper wire and fiber optics, and may take the form of acoustic or light waves, such as those generated during radio-wave and infra-red data communications.

Also, while the orders of operation have been discussed and illustrated in relation to a particular sequence of events, it should be appreciated that changes, additions, and omissions to this sequence may occur without materially affecting the operation of the disclosed embodiments, configuration, and aspects.

A number of variations and modifications of the disclosure may be used. It would be possible to provide for some features of the disclosure without providing others.

In yet another embodiment, the systems and methods of this disclosure may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein may be used to implement the various aspects of this disclosure. Exemplary hardware that may be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing may also be constructed to implement the methods described herein.

In yet another embodiment, the disclosed methods may be readily implemented in conjunction with software using object or object-oriented software development environments that provide portable source code that may be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that may be stored on a storage medium, executed on programmed general-purpose computer with the cooperation of a controller and memory, a special purpose computer, a microprocessor, or the like. In these instances, the systems and methods of this disclosure may be implemented as program embedded on personal computer such as an applet, JAVA® or CGI script, as a resource residing on a server or computer workstation, as a routine embedded in a dedicated measurement system, system component, or the like. The system may also be implemented by physically incorporating the system and/or method into a software and/or hardware system.

The preceding is a simplified summary of the disclosure to provide an understanding of some aspects of the disclosure. This Summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

The Description of the invention, the drawing figures, and any exemplary claim set forth herein, taken in conjunction with this Summary of the invention, define the invention.

### BRIEF DESCRIPTION OF THE DRAWINGS

FIG. 1 depicts a first and second side of the slide assembly in an extended position of certain embodiments.

FIG. 2 depicts a cargo lowering slide assembly of certain embodiments showing a first and second sides of a slide assembly in an extended position with interconnected scissor arms and cargo platform in a retracted or lifted position.

FIG. 3 depicts a first and second side of the drawer slide with interconnected scissor arms and cargo platform in an extended or lowered position in certain embodiments of a cargo lowering slide assembly.

FIGS. 4A-C depicts a side of the slide assembly with interconnected scissor arms and cargo platform in retracted, intermediate, and extended positions of a cargo lowering slide assembly showing in certain embodiments.

FIG. 5 depicts certain embodiments of cargo lowering slide assembly in a horizontally retracted position with the cargo platform within a storage compartment or enclosure.

FIG. 6 depicts certain embodiments of the cargo lowering slide assembly with the cargo platform in a horizontally extended position outside of the storage compartment or enclosure.

FIG. 7 depicts certain embodiments of a cargo lowering slide assembly with the cargo platform in a horizontally extended and vertically lowered position outside of the storage compartment or enclosure.

FIGS. 8A-D depicts certain embodiments of a cargo lowering slide assembly showing a side of the slide assembly with interconnected scissor arms and cargo platform in retracted, intermediate, and extended positions.

FIGS. 9A-D depicts certain embodiments of a cargo lowering slide assembly showing a side of the slide assembly with interconnected scissor arms and cargo platform in retracted, intermediate, and extended positions.

FIG. 10 depicts certain embodiments of a cargo lowering slide assembly in a horizontally retracted position with the cargo platform within a storage compartment or enclosure.

FIG. 11 depicts certain embodiments of a cargo lowering slide assembly with the cargo platform in a horizontally extended position outside of a storage compartment or enclosure.

FIG. 12 depicts certain embodiments of a cargo lowering slide assembly with a cargo platform in a horizontally extended and vertically lowered position outside of a storage compartment or enclosure.

FIG. 13 depicts the scissor arm configuration in certain embodiments showing a first side portion of the actuator devices.

FIG. 14 depicts the scissor arm configuration in certain embodiments showing a second side portion of the actuator devices.

FIG. 15 depicts certain embodiments of the cargo lowering slide assembly.

### DETAILED DESCRIPTION OF VARIOUS EMBODIMENTS

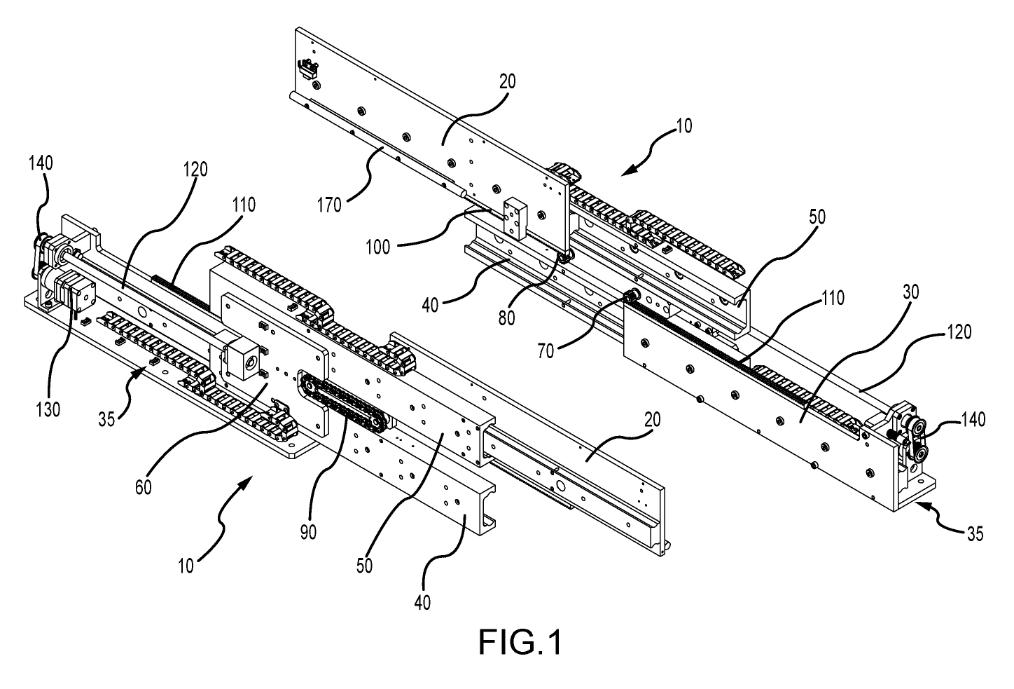

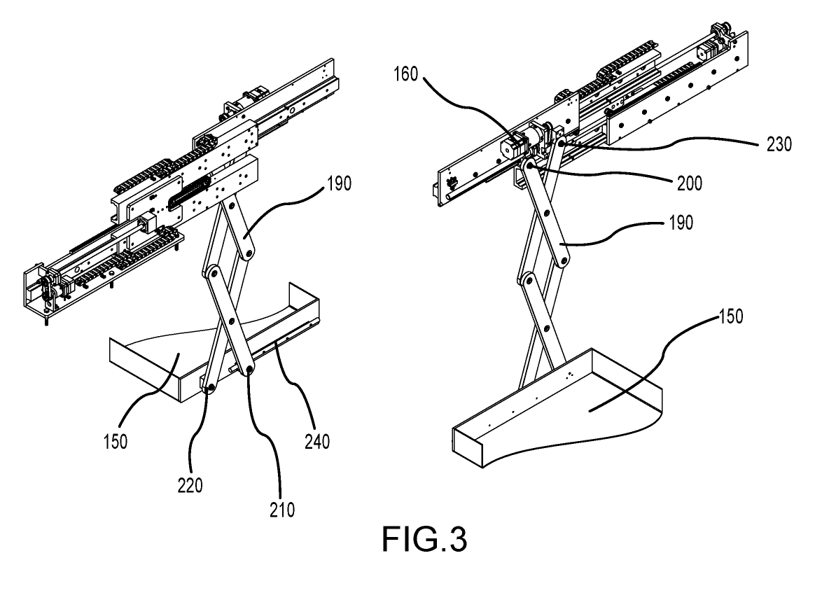

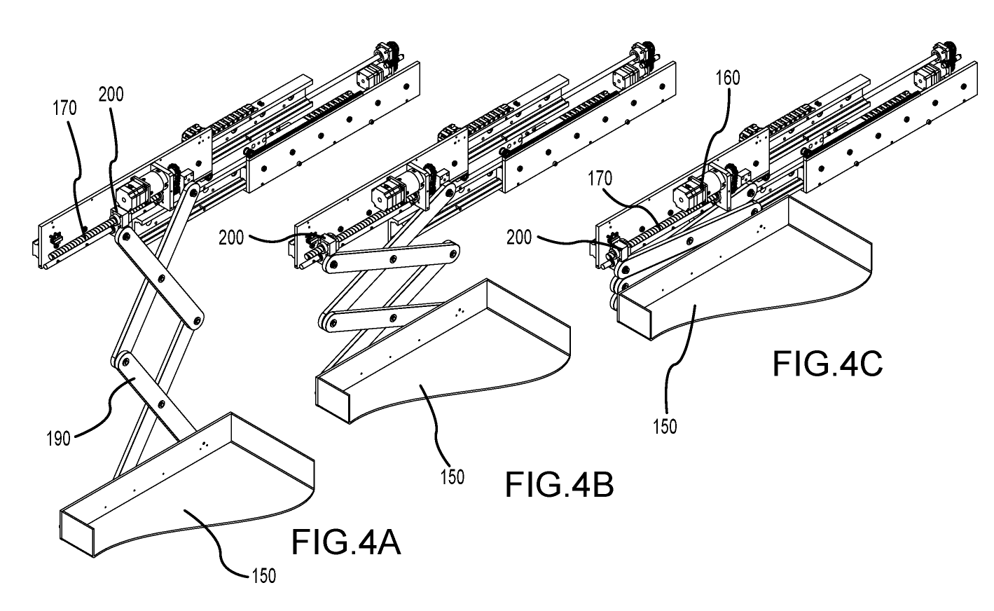

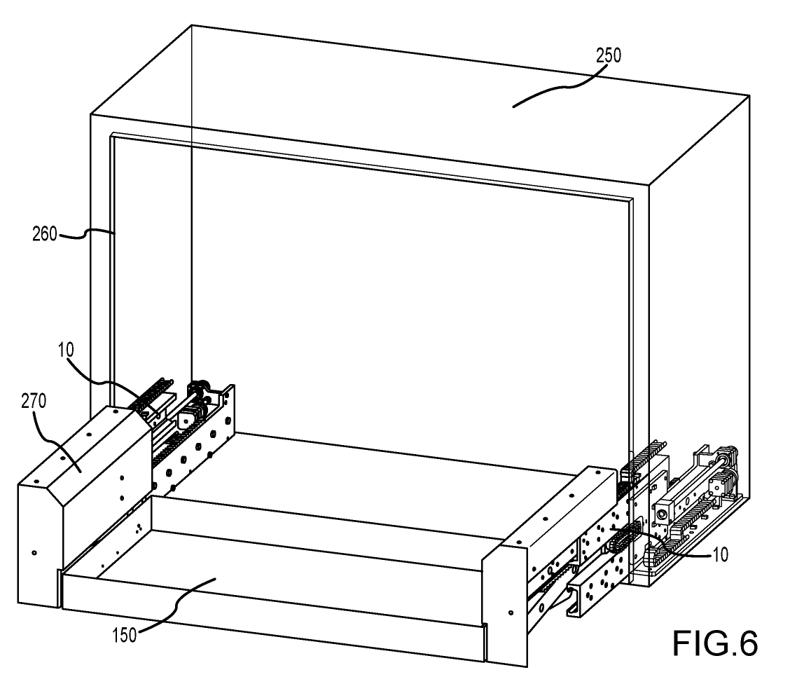

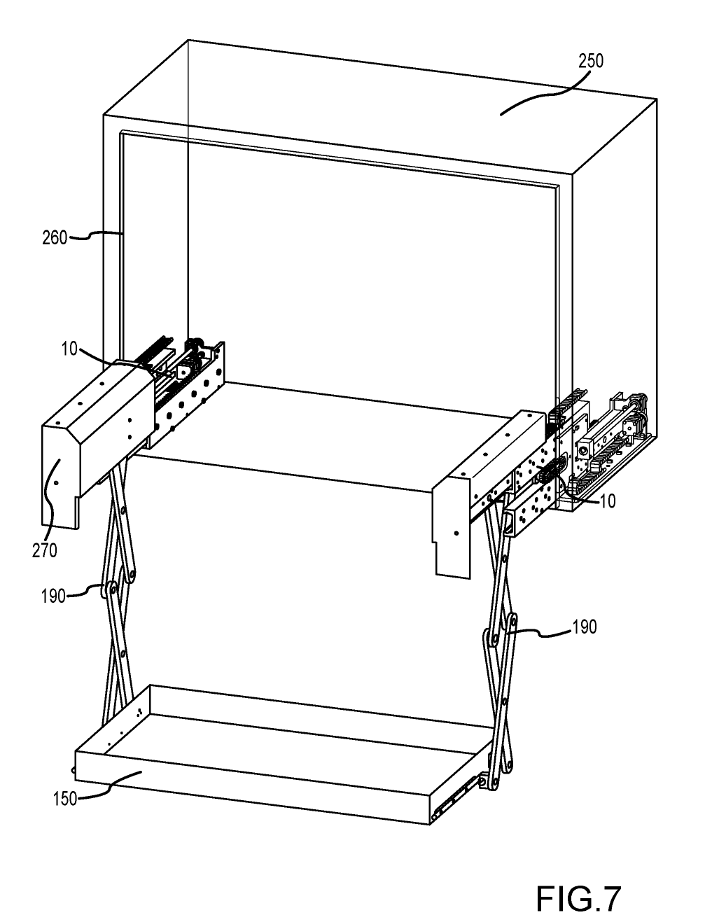

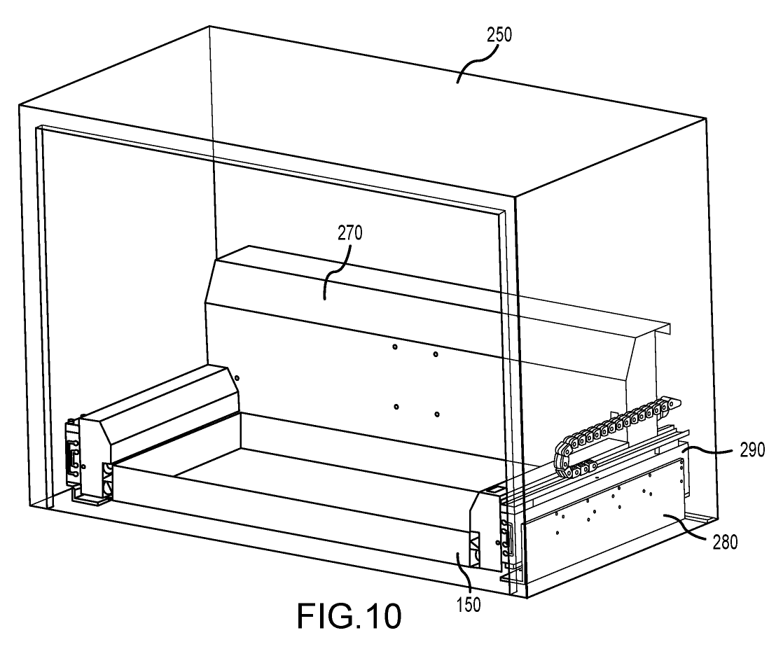

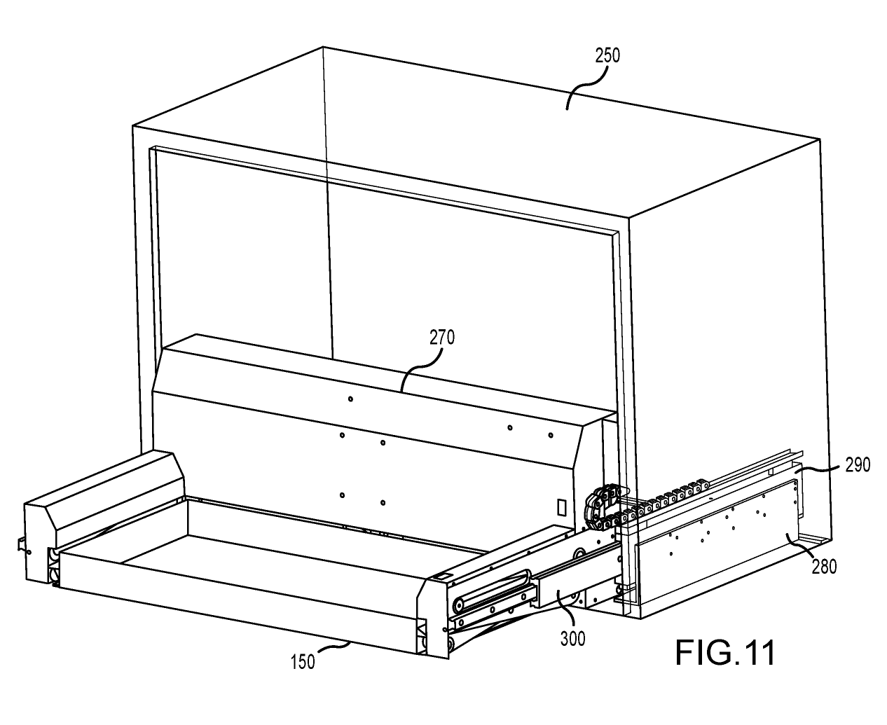

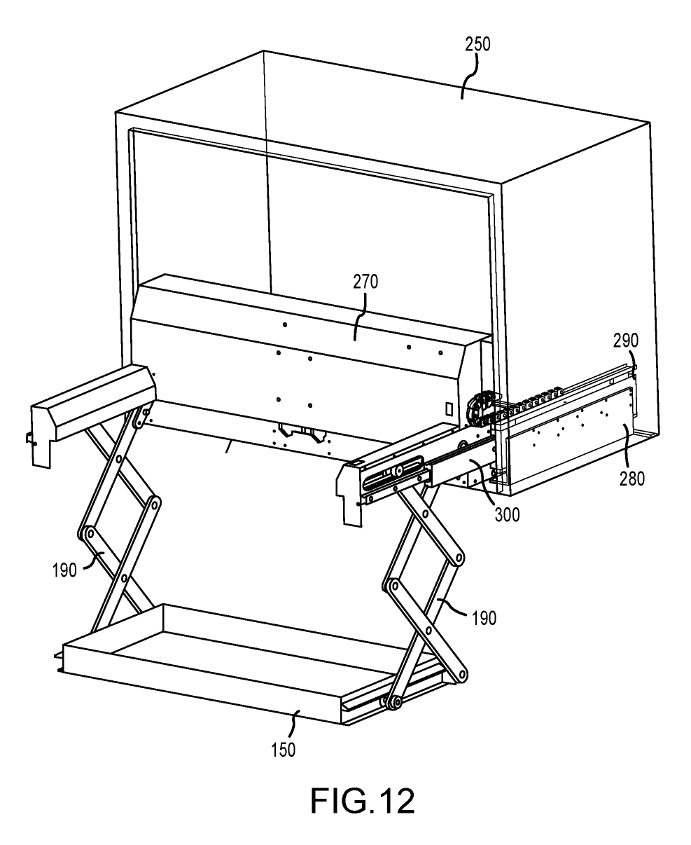

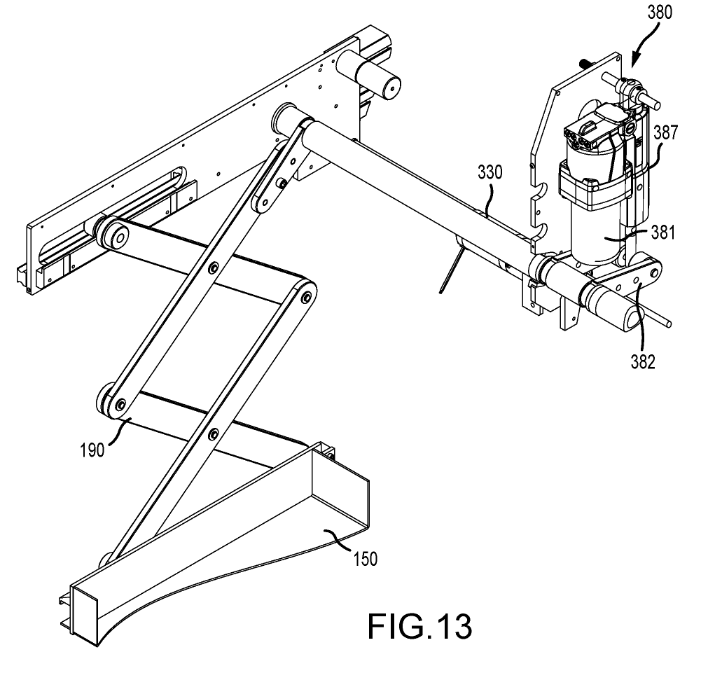

The cargo lowering slide assembly generally comprises two drawer slide assemblies 10, two scissor arm assemblies 190, and a cargo platform 150, as seen in FIGS. 1-15. The cargo lowering slide assembly is adapted to be mounted within an enclosure 250, but may also be mounted to a surface that is not enclosed such as on the top of a vehicle or in the bed of a pickup truck.

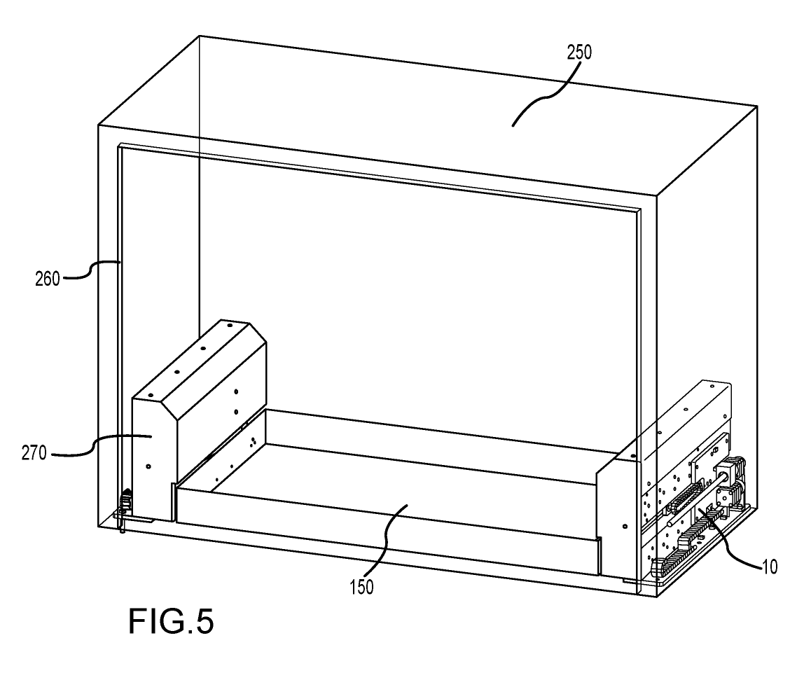

As seen in FIGS. 5-7 and 10-12, the enclosure 250 may be any enclosure suitable for storing cargo, but generally includes three side walls, a top, a bottom, and a door opening 260. The door opening may include a door (not shown) such as a tip up door, a sliding door, or a roll up door. The enclosure 250 may be attached or integrated into the body or chassis of a vehicle (not shown) such as a firetruck or emergency response vehicle.

In certain embodiments the cargo lowering slide assembly, the slide assembly 10, as shown in FIGS. 1 through 7, is generally comprised of elements 20 through 140. Lower slide plate 30 includes a foot 35 for mounting the slide assembly to the bottom of the enclosure 250 or to another surface. The lower slide plate 30 is slideably engaged with lower slide sleeve 40. In certain embodiments, the slideable engagement comprises ball bearing slides. Lower slide sleeve 40 is interconnected to upper slide sleeve 50 by bridge 60. Upper slide sleeve 50 is slideably engaged with upper slide plate 20, In certain embodiments, the slideable engagement comprises ball bearing slides. Lower rack gear 110 is interconnected to the top edge of lower slide plate 30, and upper rack gear 100 is interconnected to the bottom edge of upper slide plate 20. The slide assembly 10 may include additional slide plates, slide sleeves, and bridges to increase the overall extended length of the slide assembly.

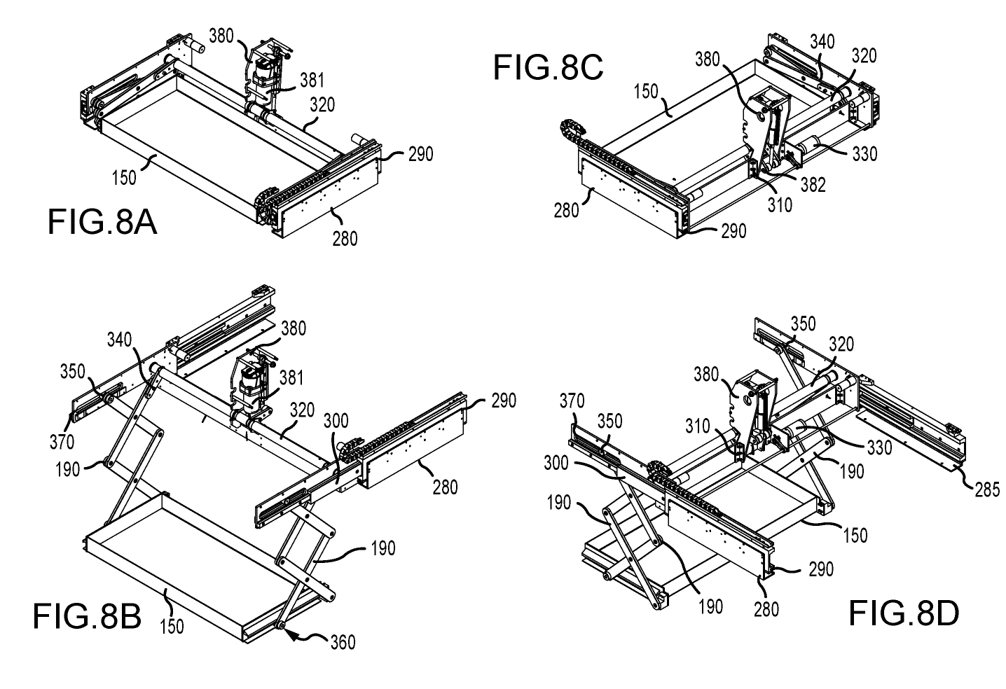

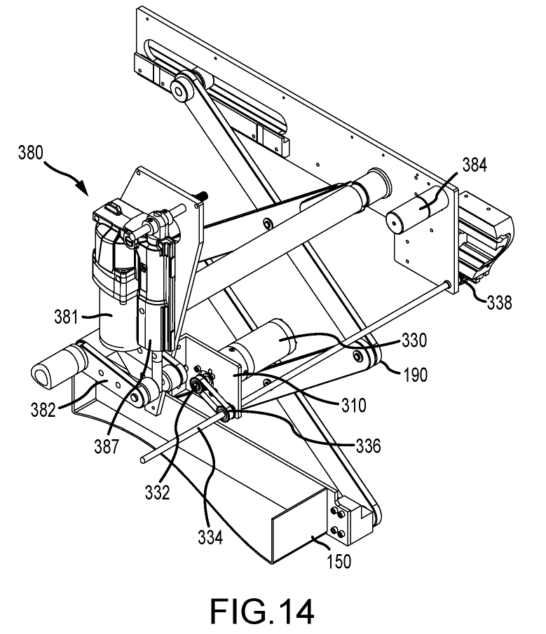

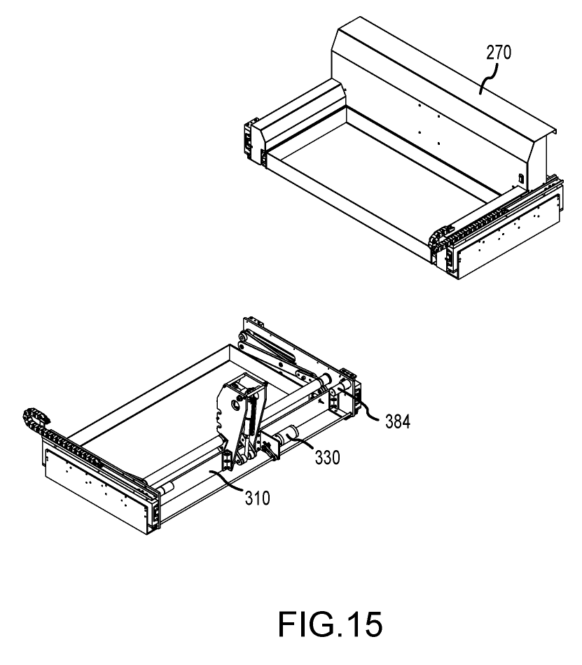

Other embodiments of the slide assembly are shown in FIGS. 8 through 15. The slide assembly includes an outer slide rail 280, a middle slide rail 290, and an inner slide rail 300 in a nested configuration. In certain embodiments, the outer slide rail 280 and middle slide rail 290 are slideably engaged by ball bearing slides, and the middle slide rail 290 and inner slide rail are slideably engaged by ball bearing slides. Outer slide rail 280 is interconnected to a foot 285 for mounting the slide assembly to the bottom of the enclosure 250 or to another surface. A rack gear 310 (seen in FIGS. 14 and 15) is interconnected to the bottom edge of outer slide rail. Inner slide rail 300 is interconnected to a slide plate similar to the upper slide plate 20. The slide plates of opposing slide assemblies may be interconnected by a beam. The slide assembly may include additional slide rails to increase the overall extended length of the slide assembly.

In certain embodiments, seen in FIGS. 1-7, slide assembly 10 is extended or contracted horizontally to move the cargo platform 150 by use of extension motor assembly 130, extension timing belt assembly 140, and extension screw 120. Activation of extension motor assembly 130 causes rotation of extension screw 120 that, in turn, converts rotation through a threaded bushing into linear thrust which is applied simultaneously to the bridge 60, the upper slide sleeve 50 and the lower slide sleeve 40. The motion of the lower slide sleeve 40 is coupled directly to the motion of the lower spur gear 70. Rotation of lower spur gear 70 against the fixed lower rack gear 110 causes lower slide sleeve 40 to extend or contract relative to lower slide plate 30. In turn, the lower spur gear 70 which is interconnected to upper spur gear 80 by synchronizer chain 90. Rotation of lower spur gear 70 therefore causes rotation of upper spur gear against upper rack gear 100 and causes upper slide plate 20 to extend or contract relative to upper slide sleeve 50. The synchronizer chain 90 causes relatively simultaneous rotation of lower spur gear 70 and upper spur gear 80 and therefore the extension and contraction of the upper and lower portions of slide assembly 10 is synchronized and amplified. In certain embodiments, the slide assembly 10 can be extended or contracted by use of a drive belt/pulley or drive chain/sprocket assembly, interconnected by mechanical fasteners, welding or by use of adhesive to the rails. Embodiments of the present invention achieve horizontal actuation by utilizing a ball screw/actuator or gearbox assembly or by an air assist type actuator that is interconnected to the slide rails and that extends and returns the slide assembly 10 to an extended or contracted position. In certain embodiments, the cargo lowering slide assembly may also include latches, pins, magnets, solenoids, springs, or other known interference devices for mechanically preventing movement of the cargo lowering slide assembly when in stored, extended, or lowered positions, as well as proximity sensors to electronically monitor and prevent movement of the cargo lowering slide assembly when in stored, extended, or lowered positions.

In other embodiments, seen in FIGS. 14 and 15, the slide assembly is extended or contracted horizontally to move the cargo platform by use of rack drive assembly. The rack drive assembly includes a motor 330 and pulley 332 and is interconnected to a pulley on a rack drive rod 334 by a belt or chain 336. Activation of the rack drive assembly motor 330 causes rotation of the rack drive rod 334 which, in turn, rotates a spur gear 338 that is engaged with the rack gear interconnected to the bottom edge of outer slide rail. Rotation of spur gear against the fixed rack gear causes the middle and inner slide rails to extend or contract relative to outer slide rail. The slide assembly could also be extended or contracted by use of a drive belt/pulley, drive chain/sprocket, or hydraulic piston assembly, interconnected by mechanical fasteners, welding or by use of adhesive to the rails.

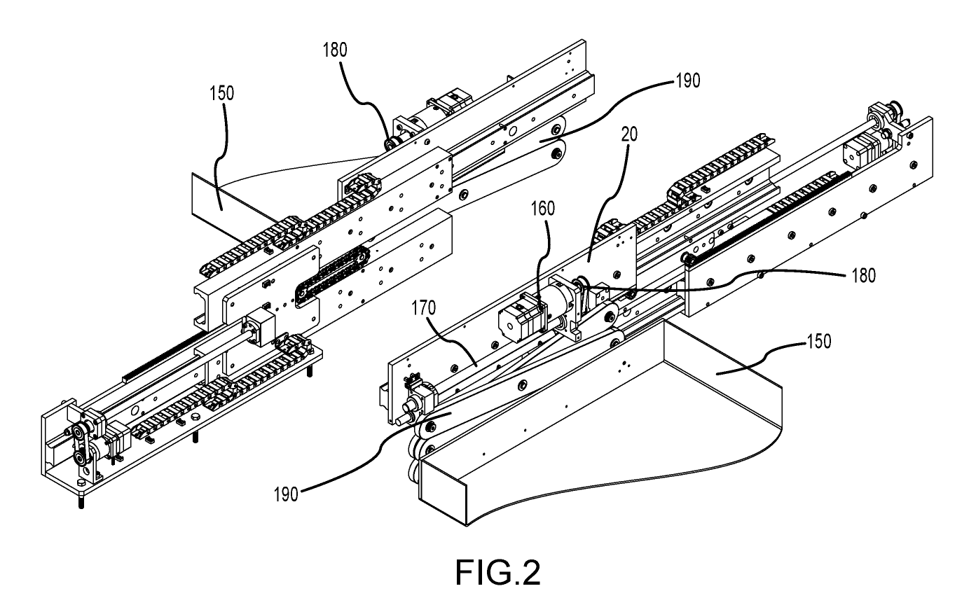

In certain embodiments, as seen in FIGS. 2-4, the lower ends of scissor arm assemblies 190 are interconnected to opposite sides of the cargo platform 150 by lower scissor pivot 220 and lower pillow block assembly 210. Cargo platform guide 240 is interconnected to the cargo platform 150 and lower pillow block assembly 210 is slideably engaged to cargo platform guide 240. The upper ends of scissor arm assemblies 190 are interconnected to respective slide assemblies 10 at upper scissor pivot 230 and upper bushing assembly 200. Certain embodiments comprise upper bushing assembly 200 screwably interconnected to scissor screw 170. The cargo platform 150 is extended or contracted vertically by use of scissor motor assembly 160, scissor timing belt assembly 180, and scissor screw 170. Scissor timing belt assembly 180 transfers rotation of scissor motor assembly 160 to scissor screw 170. In turn, rotation of scissor screw 170 causes upper bushing assembly 200 to travel outward or inward depending upon the direction of rotation of scissor screw 170. Movement of upper bushing assembly 200 relative to upper scissor pivot 230 causes the scissor arm assembly 190 to extend or contract in a scissor motion. Extension or contraction of the scissor arm assembly 190 may also be achieved with a series of cables and pulleys, screws, or by hydraulic actuation. The cargo platform 150 may also be raised or lowered using telescopic actuation. In other embodiments, cargo platform 150 may be raised or lowered using rods, telescoping mechanisms, hydraulic pistons, treaded rods with nuts, a plurality of screws and bushings or hydraulic cylinders or any combination of mechanisms to raise and lower a platform. As seen in FIGS. 5, 6, 10, 11, 12 and 15, the scissor arm and slide assemblies can be covered by a shroud 270, in certain embodiments when in a retracted position.

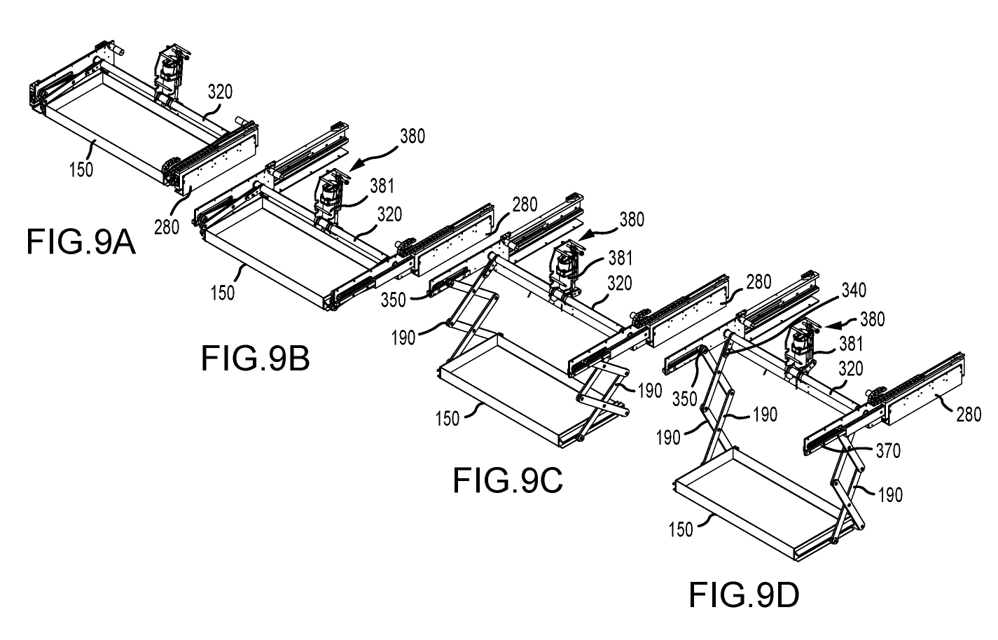

In certain embodiments, seen in FIGS. 8 and 9 the lower ends of scissor arm assemblies 190 are interconnected to opposite sides of the cargo platform 150 by a lower scissor pivot 220 and a lower roller 360. The roller is slideably engaged with a channel attached to the cargo platform 150. The upper ends of scissor arm assemblies 190 are interconnected to respective slide assemblies at a scissor shaft 320 and an upper roller 350. The upper roller 350 is slideably engaged with a channel 370 integrated into the slide plate. The first end of a lever arm 382 is affixed to the scissor shaft 320 near the middle of the scissor shaft length. As seen in FIGS. 8, 9, 13, and 14 a scissor actuator assembly 380 including a hydraulic piston 381 is interconnected to the scissor shaft 320. The arm of the piston 387 is rotatably interconnected to the second end of the lever arm 382. The extension or retraction of the piston arm 387 causes the scissor shaft 320 to rotate. In turn, rotation of the scissor shaft 320 causes the scissor arm assembly 190 to extend or contract in a scissor motion and thereby lower or raise the cargo platform 150. A solenoid locking mechanism 384 can be used to keep the sliding mechanism and the extending arms in a desired position.

In one embodiment, the adjustment of one or more elements are facilitated or enabled by electromechanical or other motion-augmented means known to those skilled in the art. Control of the electric, electric hydraulic or air actuator devices in the present invention may be achieved via numerous methods including mechanical actuated electrical switches mounted directly to the cargo lowering slide assembly or via wireless switching mechanisms including smart phone actuation or integration into vehicle multiplexing networks. These control systems may include mechanical, electro-mechanical, or module to control the sequence of extension, lowering, raising, and retraction of the cargo lowering slide assembly. For example, the control system may include proximity switches or a module that prohibits the cargo lowering slide assembly from: (1) extending horizontally unless the door of the enclosure is in a fully opened position; (2) lowering the cargo platform unless the slide assemblies are in a fully extended position; or (3) retracting horizontally unless the scissor arms are in a fully retracted or raised position. The cargo lowering slide assembly may also include sensors or a module to warn if the weight of the load in the cargo platform exceeds design parameters. The cargo lowering slide assembly may also include motor overload protection for sensing such events as jamming of the horizontal or vertical movement of the assembly. The cargo lowering slide assembly may also include audio and/or visual indicators to indicate or warn the user that the slide assembly will be moving or is moving. In one embodiment, the electromechanical or other motion-augmented means are interconnected and/or in communication with a controller that controls the positioning or movement of the cargo lowering slide assembly.

The structural materials employed advantageously in the present invention are fashioned from machined plastics, extruded, machined, or cast aluminum or stainless steel, and although several suitable alternatives are available, as one skilled in the art would recognize readily. Likewise, any padding, where padding is desirable, is preferably some kind of foamed elastomer, though other suitable materials exist. Other hardware, brackets, locking pins and supports may be fashioned from aluminum, stainless steel, brass, or other suitable material. One of ordinary skill in the art will appreciate that embodiments of the present disclosure may be constructed of materials known to provide, or predictably manufactured to provide the various aspects of the present disclosure. These materials may include, for example, stainless steel, titanium alloy, aluminum alloy, chromium alloy, and other metals or metal alloys. These materials may also include, for example, carbon fiber, ABS plastic, polyurethane, and other fiber-encased resinous materials, synthetic materials, polymers, and natural materials. The system and its elements could be flexible, semi-rigid, or rigid and made of materials such as stainless steel, titanium alloy, aluminum alloy, chromium alloy, and other metals or metal alloys, carbon fiber, ABS plastic, polyurethane, and other fiber-encased resinous materials, synthetic materials, polymers, and natural materials. In one embodiment, some or all components are manufactured by way of 3-D printing.

The exemplary systems and methods of this disclosure have been described in relation to firetrucks and rescue vehicles and associated operations. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration.

Moreover, though the Description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A cargo loading device comprising:
a first slide assembly comprising at least one slide plate and a sleeve;
a second slide assembly comprising at least one slide plate and a sleeve;
a first extendable arm interconnected to the first slide assembly;
a second extendable arm interconnected to the second slide assembly;
a platform having one side interconnected to a distal end of the first extendable arm and having a second side interconnected to a distal end of the second extendable arm; and
a compartment, wherein said first slide assembly, second slide assembly, and platform are housed within said compartment when in a retracted position.

2. The cargo loading device of claim 1 wherein each of the first and second extendable arms comprises a scissor mechanism.

3. The cargo loading device of claim 1 wherein each of the first and second extendable arms comprises a rod.

4. The cargo loading device of claim 3 wherein the rods comprise a telescoping rod.

5. The cargo loading device of claim 3 wherein the rods comprise hydraulic pistons.

6. The cargo loading device of claim 3 wherein the rods comprise threaded rods and at least one threaded bushing.

7. The cargo loading device of claim 1 further comprising a motor assembly, the motor assembly configured to extend and retract the first and second slide assemblies.

8. A cargo loading assembly comprising:
a storage compartment having a door;
a first slide assembly comprising at least one slide plate, the slide plate comprising a rail;
a second slide assembly comprising at least one slide plate, the slide plate comprising a rail;
the first slide assembly interconnected to a first extendable scissor arm at a proximal end of the first extendable scissor arm;
the second slide assembly interconnected to a second extendable scissor arm at a proximal end of the second extendable scissor arm;
a platform having one side interconnected to a distal end of the first extendable scissor arm and having a second side interconnected to a distal end of the second extendable scissor arm; wherein said first slide assembly, second slide assembly, and platform are housed within said compartment when in a retracted position.

9. The cargo loading assembly of claim 8 further comprising:
an actuator, the actuator comprising a piston having an arm,
a shaft, the shaft interconnected to the first slide assembly at a first end of the shaft and interconnected to the second slide assembly at a second end of the shaft; and
the arm interconnected to a lever for rotating the shaft.

10. The cargo loading assembly of claim 8 wherein the platform has a first position, a second position, and a third position.

11. The cargo loading assembly of claim 10 wherein the extendable scissor arms are configured to be retracted in the first position.

12. The cargo loading assembly of claim 10 wherein the extendable scissor arms are configured to be retracted in the second position.

13. The cargo assembly of claim 10 wherein the slide assemblies are configured to be extended in the third position.

14. The cargo assembly of claim 10 wherein the slide assemblies are configured to be retracted when the storage compartment door is in a closed position.

15. The cargo assembly of claim 12 further comprising a control module for retaining the scissor arms in a retracted position.

16. The cargo assembly of claim 13 further comprising a control module for retaining the slide assemblies in an extended position.

17. An assembly for loading and storing cargo comprising:
a platform having one side interconnected to a distal end of a first extendable arm and having a second side interconnected to a distal end of a second extendable arm;
a compartment;
a first slide assembly comprising at least one slide plate;
a second slide assembly comprising at least one slide plate;
the first extendable arm interconnected to a proximal end of the first slide assembly;
the second extendable arm interconnected to a proximal end of the second slide assembly; and
a control module configured to extend and retract the first and second slide assembly and to raise and lower the platform.

18. The cargo assembly of claim 17 wherein the control module is configured to retain the platform in a raised or lowered position.

19. The cargo assembly of claim 18 wherein the control module is configured to retain the slide assemblies in an extended or retracted position.
